(19) United States
(12) Patent Application Publication
(10) Pub. No.: US 2007/0075543 A1
(43) Pub. Date: Apr. 5, 2007

(54) Connection

(75) Inventors: Peter Marx, Wasbuettel (DE); Ralf Muehlhausen, Rotenburg (DE)

Correspondence Address: MAYER, BROWN, ROWE & MAW LLP, P.O. BOX 2828, CHICAGO, IL, 60690-2828, US

(73) Assignee: SIEMENS AKTIENGESELLSCHAFT, MUNICH (DE)

(21) Appl. No.: 10/556,109

(22) PCT Filed: Apr. 19, 2004
(86) PCT No.: PCT/EP04/04152

§ 371 Date: Nov. 8, 2005

(30) Foreign Application Priority Data
May 15, 2003 (DE) 103 22 090.9

(51) Int. Cl. F16L 13/02; F16L 25/00

(52) U.S. Cl. 285/331; 285/903; 285/288.1

(57) ABSTRACT

The invention relates to a connection (7) of a fuel supply device in a motor vehicle, which is characterized in that a corrugated hose (5) is held in a peripheral groove (10) of a connection piece (8) by means of a glue (12) and in that the groove (10) protrudes from an undulation of the corrugated hose (5). The corrugated hose (5) can thus be connected to the connection piece (8) with very little effort. The connection (7) is also inexpensive to produce.

The invention relates to a connection, in particular a connection of a fuel supply device in a motor vehicle, for a corrugated hose on a connection piece.

Such connections are used in fuel supply devices to connect, for example, a fuel pump which is arranged in the fuel tank to a coupling (which is arranged on a flange of the fuel tank) for a feed line which leads to an internal combustion engine. Suction jet pumps which are likewise connected to the fuel pump via a corrugated hose are also arranged within the fuel tank. The corrugated hose is generally manufactured from the polymer PA 11 (polyamide). The fuel pump, the flange and the suction jet pump each have connection pieces for this. In the case of connections which are known from practice, the corrugated hoses are clamped tightly on the connection pieces using a clip and, in the process, are sealed and secured against being released. The clip has staples which are bent against the hose.

The disadvantage of the connection which is known from practice is that the clip is difficult to handle and the clips are an expensive component.

The invention is based on the problem of configuring a connection of the type mentioned at the beginning in such a manner that it allows the corrugated hose to be connected to the connection piece in a particularly simple manner, and in such a manner that it is particularly cost-effective.

According to the invention, this problem is solved by virtue of the fact that the connection piece has a peripheral groove and the corrugated hose is integrally fastened materially in the groove.

This configuration makes it possible for the corrugated hose to be inserted into the groove in a simple manner during installation and to be integrally connected materially to the connection piece there. As a result, the corrugated hose is fastened to the connection piece and is simultaneously sealed with respect to the latter. Thanks to the invention, a clip for retaining the corrugated hose can be avoided, thus resulting in low costs of the connection according to the invention. The connection according to the invention is particularly simple to install since, in addition to the corrugated hose and the connection piece, there is no need for any additional components.

In accordance with one advantageous development of the invention, the corrugated hose is integrally connected materially to the connection piece in a particularly simple manner, in terms of design, if the groove is filled with adhesive. As a result, the corrugated hose is simply pushed into the groove for the purposes of installation and is fixed until the adhesive has cured. In this case, the cured adhesive can engage, at least partially, behind corrugations of the corrugated hose and can additionally secure the corrugated hose in a positively locking manner. Since the corrugated hose can be connected to the connection piece over a very large area using a particularly small amount of adhesive, the connection according to the invention is additionally sealed in a particularly reliable manner. The adhesive may be virtually any desired substances which enable a connection to the materials of the connection piece and of the corrugated hose.

In accordance with another advantageous development of the invention, the use of adhesive for connecting the connection piece to the corrugated hose can be avoided if an edge of the groove is manufactured from a material which is permeable to a laser beam of an intended wavelength and the corrugated hose is manufactured from a material which is impermeable to the laser beam. As a result, the corrugated hose can be connected to the connection piece in a simple manner in the laser welding method using the laser beam which is led through the edge. It goes without saying that it is also conceivable to reverse the materials, so that the laser beam is led through the corrugated hose.

A contribution is made to simplifying the installation of the connection according to the invention if the groove has means for retaining the corrugated hose in a positively locking manner. This makes it possible for the corrugated hose to be fixed in a simple manner, for example while the adhesive is curing.

In accordance with another advantageous development of the invention, the means for retaining the corrugated hose in a positively locking manner require particularly low structural expenditure if the edge which bounds the groove has a projection which points radially inward. This projection can engage behind a corrugation of the corrugated hose.

A contribution is made to further simplifying the installation of the connection according to the invention if the internal diameter of the groove is slightly larger than the internal diameter of the corrugated hose. As a result, the corrugated hose is held on the connection piece in a frictionally locking manner and fixed in its position during the integral material connection operation.

In accordance with another advantageous development of the invention, the corrugated hose can be inserted into the groove in a simple manner during installation if the internal diameter of the groove is larger than the external diameter of the free end of the connection piece. The junction between the diameter of the free end of the connection piece and the internal diameter of the groove preferably has a bevel.

In accordance with another advantageous development of the invention, the groove can be widened in a simple manner when inserting the corrugated hose and can then clamp the corrugated hose if the edge is elastic.

In the case of the groove which is filled with adhesive, the corrugated hose, in accordance with another advantageous development of the invention, can be secured, in a positively locking and simple manner, against being withdrawn if the groove is deeper than at least one corrugated section of the corrugated hose.

### The invention permits numerous embodiments. Two of these are illustrated in the drawing and are described below in order to further explain the basic principle of the invention. In the drawing:

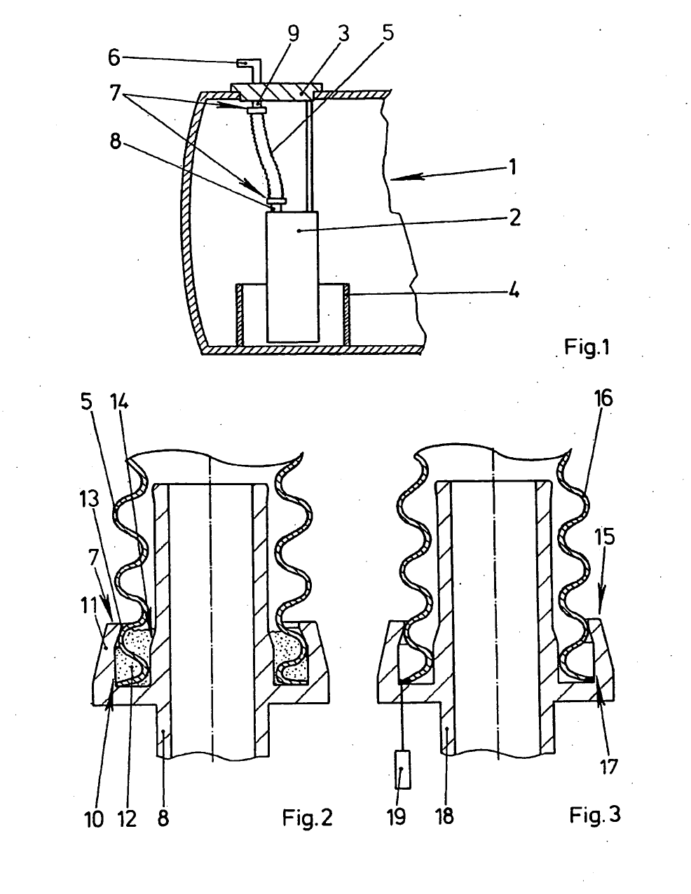

FIG. 1 schematically shows a partial region of a fuel tank having a fuel feed unit for a motor vehicle,

FIG. 2 shows, on a greatly enlarged scale, a longitudinal section through a connection according to the invention of the fuel feed unit from FIG. 1, and

FIG. 3 shows, on a greatly enlarged scale, another embodiment of the connection according to the invention.

FIG. 1 schematically shows a sectional view of a partial region of a fuel tank 1 having a fuel feed unit 2 which is arranged in the latter. The fuel feed unit 2 is fastened to a flange 3 of the fuel tank 1 and is supported in the bottom region of a surge chamber 4. A corrugated hose 5 is used to connect the fuel feed unit 2 to a connector 6 which is arranged on the flange 3. The corrugated hose 5 may be manufactured, for example, from the polymer PA 11 (polyamide). A feed line (not illustrated) which leads to an internal combustion engine of the motor vehicle may be connected to the connector 6. At each of its ends, the corrugated hose 5 has a connection 7 on a connection piece 8, 9 of the flange 3 and of the fuel feed unit 2. It goes without saying that further corrugated hoses (not illustrated), for example for a suction jet pump or a return line, may be connected to the flange 3 and to the fuel feed unit 2.

FIG. 2 shows, on a greatly enlarged scale and by way of example, a longitudinal section through one of the connections 7 from FIG. 1. It can be seen in this case that the connection piece 8 has a peripheral groove 10 into which the end of the corrugated hose 5 projects. The groove 10 is bounded, in its radially outer region, by a slightly elastic edge 11 and is filled with adhesive 12. In this case, the height of the edge 11 exceeds one corrugation of the corrugated hose 5. The edge 11 has a peripheral projection 13 which points inward and rests against the corrugated hose 5. The internal diameter of the groove 10 is slightly larger than the internal diameter of the corrugated hose 5 and the external diameter of the connection piece 8. As a result, the corrugated hose 5 is held in its intended position until the adhesive 12 cures. The junction between the internal diameter of the groove 10 and the connection piece 8 has a peripheral bevel 14 in order to make it possible to insert the corrugated hose 5 into the groove 10 in a simple manner.

FIG. 3 shows a connection 15 in which a corrugated hose 16 is welded to the bottom of a groove 17 in a connection piece 18. Welding is effected using a laser gun 19 (illustrated schematically). The connection piece 18 is manufactured from a material which is permeable to the laser beam, while the corrugated hose 16 absorbs the laser beam at least at its end and, in the process, is heated above its melting point and is connected to the material of the connection piece 18. The connection 15 from FIG. 3 is otherwise constructed like the connection from FIG. 2.

1. A connection, in particular a connection of a fuel supply device in a motor vehicle, for a corrugated hose on a connection piece, characterized in that the connection piece (8, 9, 18) has a peripheral groove (10, 17), and in that the corrugated hose (5, 16) is integrally fastened materially in the groove (10, 17).

2. The connection as claimed in claim 1, characterized in that the groove (10) is filled with adhesive (12).

3. The connection as claimed in claim 1 or 2, characterized in that an edge of the groove (17) is manufactured from a material which is permeable to a laser beam of an intended wavelength and the corrugated hose (16) is manufactured from a material which is impermeable to the laser beam.

4. The connection as claimed in claim 1, characterized in that the groove (10, 17) has means for retaining the corrugated hose (5, 16) in a positively locking manner.

5. The connection as claimed in claim 1, characterized in that the edge (11) which bounds the groove (10, 17) has a projection (13) which points radially inward.

6. The connection as claimed in claim 1, characterized in that the internal diameter of the groove (10, 17) is slightly larger than the internal diameter of the corrugated hose (5, 16).

7. The connection as claimed in claim 1, characterized in that the internal diameter of the groove (10, 17) is larger than the external diameter of the free end of the connection piece (8, 9, 18).

8. The connection as claimed in claim 1, characterized in that the edge (11) is elastic.

9. The connection as claimed in claim 1, characterized in that the groove (10, 17) is deeper than at least one corrugated section of the corrugated hose (5, 16).
